(19) United States
(12) Patent Application Publication
(10) Pub. No.: US 2024/0015138 A1
(43) Pub. Date: Jan. 11, 2024

(54) COMMUNICATION DEVICE AND NON-TRANSITORY COMPUTER-READABLE RECORDING MEDIUM STORING COMPUTER READABLE INSTRUCTIONS FOR COMMUNICATION DEVICE

(71) Applicant: BROTHER KOGYO KABUSHIKI KAISHA, Nagoya (JP)

(72) Inventor: Satoru YANAGI, Obu (JP)

(21) Appl. No.: 18/347,931

(22) Filed: Jul. 6, 2023

(30) Foreign Application Priority Data
Jul. 8, 2022 (JP) 2022-110692

(51) Int. Cl. H04L 9/40

(52) U.S. Cl. CPC H04L 63/0236; H04L 63/20; H04L 63/10

(57) ABSTRACT

A communication device may include a memory configured to store a first application program corresponding to a first communication port and not to store a second application program corresponding to a second communication port, and a controller. The controller may be configured to: in a case where a first request signal for the first communication port is received in a state where the first communication port is enabled, execute a process according to the first request signal by the first application program; and in a case where a second request signal for the second communication port is received in a state where the second communication port is enabled, execute a security process related to security of the communication device.

### REFERENCE TO RELATED APPLICATION

This application claims priority from Japanese Patent Application No. 2022-110692 filed on Jul. 8, 2022. The entire content of the priority application is incorporated herein by reference.

### BACKGROUND ART

An information processing device including a plurality of ports is known. When receiving a packet for a port for use other than printing, the information processing device stores a network address of the sender of the packet as a suspicious address in association with the port. When receiving a packet that is for a different port than the above-mentioned port and includes the stored suspicious address as its sender's address, the information processing device registers the stored suspicious address in a port scanner list. When receiving a packet that includes a network address on the port scanner list as its sender's address, the information processing device discards the packet without starting a port application program.

### DESCRIPTION

Disclosed herein is a technique that can enhance security of a communication device in a novel way.

A communication device disclosed herein may comprise: a memory configured to store a first application program corresponding to a first communication port and not to store a second application program corresponding to a second communication port, and a controller. The controller may be configured to: in a case where a first request signal for the first communication port is received in a state where the first communication port is enabled, execute a process according to the first request signal by the first application program; and in a case where a second request signal for the second communication port is received in a state where the second communication port is enabled, execute a security process related to security of the communication device.

According to the above configuration, the communication device does not store the application program corresponding to the second communication port in the memory. Therefore, the second request signal for the second communication port may be an illegitimate request signal. When receiving the second request signal, the communication device thus executes the security process to enhance the security of the communication device.

A computer program for implementing the above-described communication device, a computer-readable recording medium storing the computer program, and a method performed by the communication device are also novel and useful.

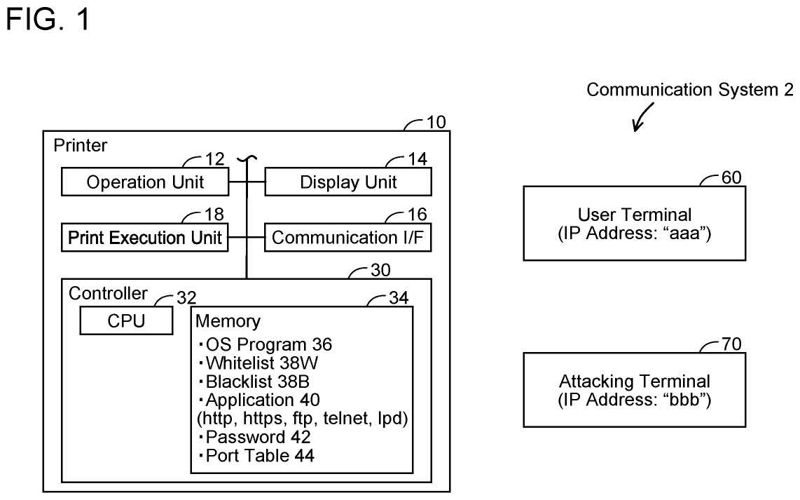

FIG. 1 shows a configuration of a communication system.

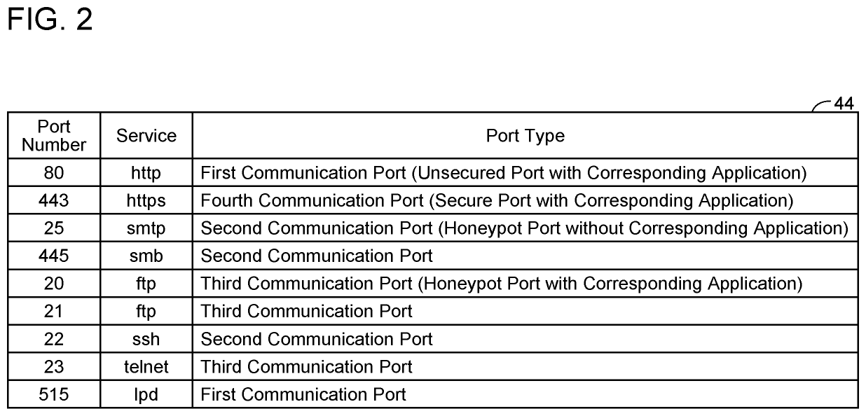

FIG. 2 shows a port table.

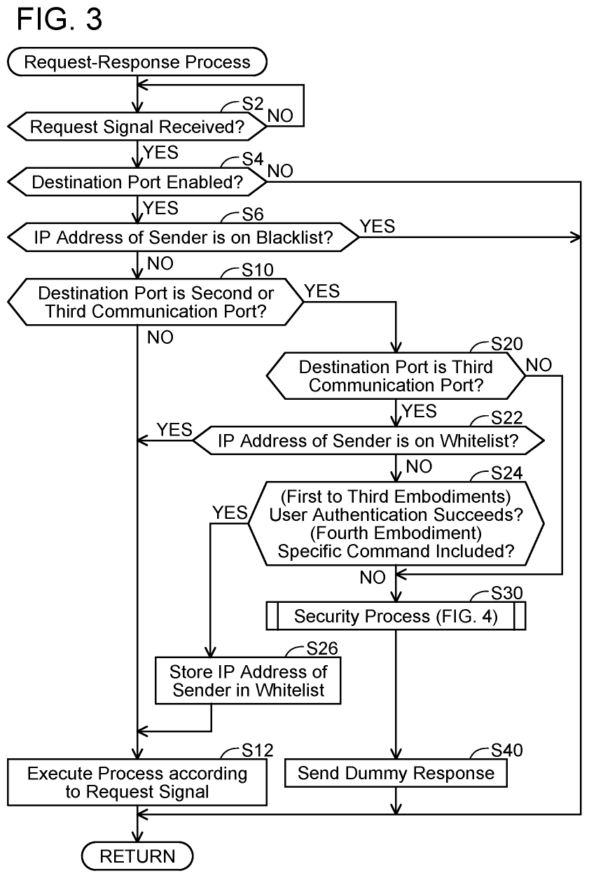

FIG. 3 shows a flowchart for a request-response process.

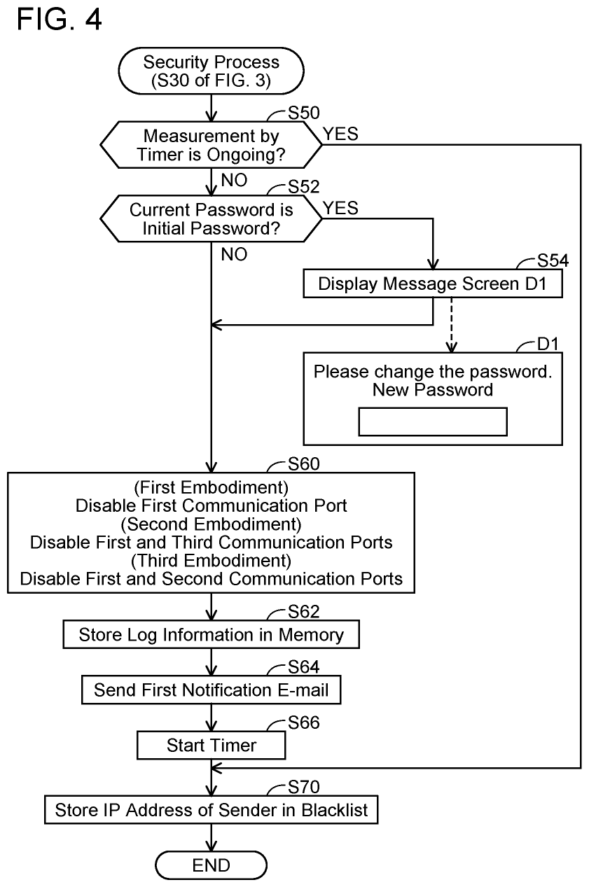

FIG. 4 shows a flowchart for a security process.

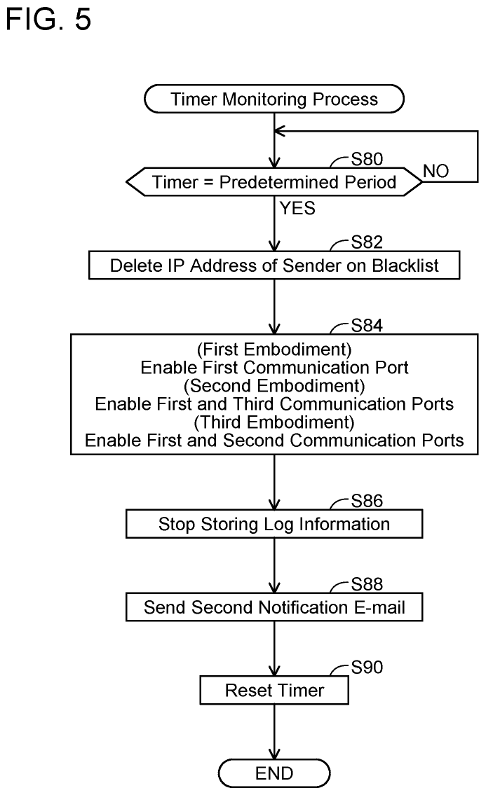

FIG. 5 shows a flowchart for a timer monitoring process.

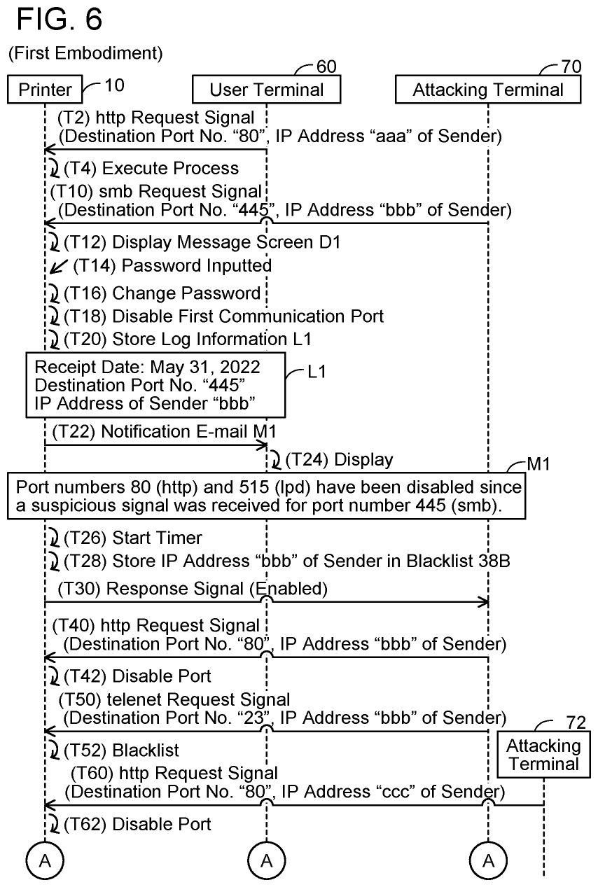

FIG. 6 shows a sequence diagram of a first embodiment.

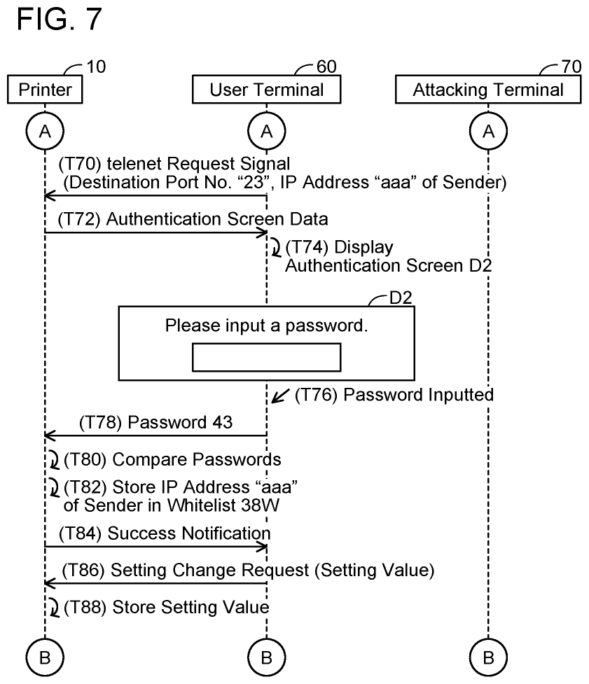

FIG. 7 shows a sequence diagram continued from FIG. 6.

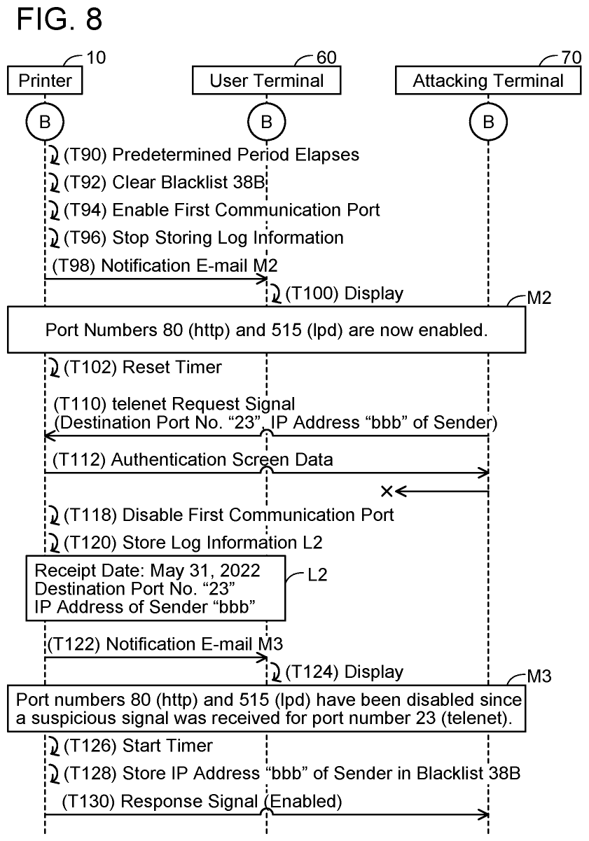

FIG. 8 shows a sequence diagram continued from FIG. 7.

### FIRST EMBODIMENT

(Configuration of Communication System 2; FIG. 1)

As illustrated in FIG. 1, a communication system 2 includes a printer 10 and a user terminal 60. The printer 10 and the user terminal 60 belong to the same LAN (local area network) and can communicate with each other via the LAN. The user terminal 60 is, for example, a terminal device such as a desktop PC, a notebook PC, a tablet PC, or a mobile phone (e.g., a smartphone). The user terminal 60 has an IP address “aaa”. In the present embodiment, it is assumed that the printer 10 is attacked by an attacking terminal 70 via the Internet. The attacking terminal 70 has an IP address “bbb”.

(Configuration of Printer 10)

The printer 10 is a peripheral device (e.g., a peripheral device of the user terminal 60) capable of executing a print function. The printer 10 includes an operation unit 12, a display unit 14, a communication interface 16, a print execution unit 18, and a controller 30. Each of the units 12 to 30 is connected to a bus line (reference sign omitted).

The operation unit 12 includes a plurality of buttons. The display unit 14 is a display configured to display various types of information. The display unit 14 also functions as a so-called touch screen (i.e., an operation unit operated by a user). The communication interface 16 is an interface for communication according to TCP/IP (Transmission Control Protocol/Internet Protocol). The print execution unit 18 includes a print mechanism of an inkjet scheme or a laser scheme.

The controller 30 includes a CPU 32 and a memory 34. The CPU 32 executes various processes in accordance with a program 36 stored in the memory 34. The memory 34 is configured of a volatile memory, a non-volatile memory, and the like. In addition to the above-mentioned program 36, the memory 34 also stores a whitelist 38W, a blacklist 38B, a plurality of applications a password 42, and a port table 44.

The whitelist 38W stores secure IP addresses as communication counterparts. In the process of FIG. 3, which will be described later, an IP address is stored in the whitelist 38W.

The blacklist 38B stores insecure IP addresses as communication counterparts. In the process of FIG. 4, which will be described later, an IP address is stored in the blacklist 38B.

The plurality of applications 40 includes five application programs (hereinafter, simply referred to as “apps”) mainly used in the present embodiment. The five apps include an app for communication and process in accordance with http (Hypertext Transfer Protocol), an app for communication and process in accordance with https (http Secure), an app for communication and process in accordance with ftp (File Transfer Protocol), an app for communication and process in accordance with telnet, and an app for communication and process in accordance with 1pd (Line Printer Daemon). In other words, each app is for communication and process in accordance with its corresponding protocol. That is, each app is for executing its corresponding service.

The password 42 is a password of the printer 10 set by the user. The password 42 is used to authenticate the user of the printer 10.

(Port Table 44; FIG. 2)

With reference to FIG. 2, the port table 44 is described. The port table 44 stores port numbers in association with their corresponding services and port types. The port numbers mean so-called well-known port numbers registered by IANA (Internet Assigned Numbers Authority). The services mean services of executing processes corresponding to the port numbers, in other words, protocols (or apps) corresponding to the port numbers. The printer 10 does not store an app corresponding to smtp (Simple Mail Transfer Protocol), an app corresponding to smb (Server Massage Block), nor an app corresponding to ssh (Secure Shell) (see the apps 40 in FIG. 1). However, in the present embodiment, port numbers corresponding to these apps, such as “25”, are assigned to the printer 10. The port types indicate which of first to fourth communication ports their corresponding port numbers fall into.

For the first, third, and fourth communication ports, their corresponding apps are stored in the printer 10. For the second communication port (e.g., port number “25” for smtp), their corresponding apps are not stored in the printer 10 and is used as a so-called honeypot. Since the printer 10 does not comprise the apps corresponding to the second communication port, the printer does not normally receive a request signal that includes the second communication port as its destination port from a terminal used by an authorized user (e.g., the user terminal 60). That is, it is highly probable that a request signal including the second communication port as its destination port is sent from a terminal (e.g., the attacking terminal 70) that is intended to cause the printer 10 to execute an illegitimate process (e.g., a request signal for so-called port scan). Therefore, when receiving a request signal including the second communication port as its destination port, the printer 10 determines that it will be probably attacked by a third party and executes a security process, which will be described later. Thus, the printer 10 uses the second communication port as a honeypot port for detecting attacks from a third party. The first communication port (e.g., port number “80” for http) is a relatively low-security communication port and is not used as a honeypot. The fourth communication port (e.g., port number “443” for https) is a relatively high-security communication port and is not used as a honeypot. The third communication port (e.g., port number “20” for ftp) has its corresponding app stored in the printer 10 but is used as a honeypot.

(Request-Response Process; FIG. 3)

Referring to FIG. 3, a request-response process is described. The request-response process is executed by the CPU 32 of the printer 10 in accordance with the program 36. The process of FIG. 3 is triggered by the printer 10 being turned on. All of the following communications executed by the printer 10 are via the communication interface 16. Therefore, in the following description, the phrase “via the communication interface 16” will be omitted in describing communication-related processes.

In S2, the CPU 32 monitors whether a request signal according to TCP/IP is received from a terminal device (e.g., the user terminal 60, the attacking terminal 70, etc.). If the request signal is received, the CPU 32 determines YES in S2 and proceeds to S4. In the following description, the terminal device, which is the sender of the request signal received here, will be referred to as “target terminal”.

In S4, the CPU 32 determines whether a destination port of the request signal is enabled or not. Specifically, the CPU 32 determines whether a port corresponding to a destination port number included in the TCP header of the request signal is enabled or not. If the port is enabled, the CPU 32 determines YES in S4 and proceeds to S6, whereas if the port is disabled, the CPU 32 determines NO in S4 and returns to S2.

In S6, the CPU 32 determines whether an IP address of the sender of the request signal (i.e., IP address of the target terminal) is on the blacklist 38B. If the IP address of the sender included in the TCP header of the request signal is not on the blacklist 38B, the CPU 32 determines NO in S6 and proceeds to S10, whereas if the IP address of the sender is on the blacklist 38B, the CPU 32 determines YES in S6 and returns to S2.

In S10, the CPU 32 determines whether the type of the destination port of the request signal is the second or third communication port (i.e., a port used as a honeypot) or not. Specifically, the CPU 32 identifies, from the port table 44, a port type corresponding to the destination port number included in the TCP header of the request signal. If the identified port type is the second or third communication port, the CPU 32 determines YES in S10 and proceeds to S20, whereas if the identified port type is the first or fourth communication port, the CPU 32 determines NO in S10 and proceeds to S12.

In S12, the CPU 32 executes a process according to the request signal. Specifically, the CPU 32 starts an app corresponding to the destination port number of the request signal and executes a process in accordance with the app.

For example, in S12 via NO in S10, the destination port number of the request signal is “80 (i.e., http)”, “443 (i.e., https)”, or “515 (i.e., fpd)”. If the destination port number of the request signal is “80 (i.e., http)” or “443 (i.e., https)” (i.e., NO in S10), the CPU 32 executes a process according to the app corresponding to http or https. This process includes, for example, a process in which the printer 10 having a webserver function sends a webpage to the target terminal. For example, if the destination port number of the request signal is “515 (i.e., fpd)” (i.e., NO in S10), the CPU 32 executes a process according to the app corresponding to fpd. This process includes, for example, a process in which the printer 10 receives print data from the target terminal and executes printing.

For example, in S12 via YES in S22 or S24, which will be described later, the destination port number of the request signal is “20 (i.e., ftp)”, “21 (i.e., ftp)”, or “23 (i.e., telnet)”. If the destination port number of the request signal is “23 (i.e., telnet)”, the CPU 32 executes a process according to the app corresponding to telnet. This process includes, for example, a process in which the printer 10 receives a setting change request and changes a setting value. If the destination port number of the request signal is “20 (i.e., ftp)” or “21 (i.e., ftp)”, the CPU 32 executes a process according to the app corresponding to ftp. This process includes, for example, a process in which the printer 10 receives a data file from the target terminal and stores it, and/or sends a data file to the target terminal. However, in recent years, the use of ftp in printers has been reduced. Thus, although the printer 10 stores the app corresponding to ftp in terms of the conventional compatibility, the printer 10 may not receive an ftp request signal from a terminal used by an authorized user. That is, it is assumed that the printer 10 receives an ftp request signal only from the attacking terminal 70. As will be described in detail later, in such circumstances, the determination of YES in S22 or S24 is not made, and thus S12 is not executed. When S12 is completed, the printer 10 returns to S2.

In S20, the CPU 32 determines whether the type of the destination port of the request signal is the third communication port or not. If the port type identified in S10 is the third communication port, the CPU 32 determines YES in S20 and proceeds to S22, whereas if the identified port type is the second communication port, the CPU 32 determines NO in S20 and skips S22 and S24 to proceed to S30.

In S22, the CPU 32 determines whether the IP address of the sender of the request signal is on the whitelist 38W or not. If the IP address of the sender included in the TCP header of the request signal is not on the whitelist 38W, the CPU 32 determines NO in S22 and proceeds to S24, whereas if the IP address of the sender is on the whitelist 38W, the CPU 32 determines YES in S22 and proceeds to S12. Thus, if the type of the destination port of the request signal is the third communication port and the IP address of the sender of the request signal is on the whitelist 38W (YES in S22), the printer 10 does not execute the security process of S30. Therefore, the printer 10 can appropriately execute a process according to the request signal from the target terminal which is a secure communication counterpart.

In S24, the CPU 32 determines whether user authentication succeeds or not. Specifically, the CPU 32 sends authentication screen data for input of a password to the target terminal, and then the CPU 32 receives a password from the target terminal. If the received password matches the password 42 of the printer 10, the CPU 32 determines YES in S24 and proceeds to S26, whereas if the received password does not match the password 42 of the printer 10 or if the printer 10 does not receive a password from the target terminal, the CPU 32 determines NO in S24 and proceeds to S30. Thus, if the type of the destination port of the request signal is the third communication port and the user authentication for the sender of the request signal succeeds (YES in S24), the printer 10 does not execute the security process of S30. The printer 10 thus can appropriately execute a process according to the request signal from the target terminal which is a secure communication counterpart.

In S26, the CPU 32 stores the IP address of the sender of the request signal (i.e., the IP address of the target terminal) in the whitelist 38W. This allows the printer 10 to determine YES in S22 when the printer 10 receives a request signal from the target terminal again, and thus the printer 10 does not need to execute S24. Thus, the processing load of the printer 10 can be reduced.

In S30, the CPU 32 executes the security process (see FIG. 4). This enhances the security of the printer 10. When S30 is completed, the CPU 32 proceeds to S40.

In S40, the CPU 32 sends a dummy response to the target terminal. The dummy response includes, for example, information indicating that the destination port of the request signal is enabled. When S40 is completed, the CPU 32 returns to S2. In a modification, the CPU 32 may not send the dummy response to the target terminal. That is, S40 may be omitted.

(Security Process; FIG. 4)

Referring to FIG. 4, the security process of S30 in FIG. 3 is described. In S50, the CPU 32 determines whether measurement by a timer is ongoing or not. The timer is started in S66, which will be described later, in order to measure a predetermined period (e.g., 60 minutes) over which the security process is continued. That is, the CPU 32 determines in S50 whether the security process (especially, disablement of a communication port) is ongoing or not. If the measurement by the timer is ongoing, that is, if the security process is ongoing, the CPU 32 determines YES in S50 and skips S52 to S66 to proceed to S70. On the other hand, if the measurement by the timer is not ongoing, that is, if the security process is not ongoing, the CPU 32 determines NO in S50 and proceeds to S52.

In S52, the CPU 32 determines whether the password 42 in the memory 34 matches an initial password that has been set since the shipping stage of the printer 10 or not. If the password 42 does not match the initial password, the CPU 32 determines NO in S52 and proceeds to S60, whereas if the password 42 matches the initial password, the CPU 32 determines YES in S52 and proceeds to S54.

In S54, the CPU 32 displays a message screen D1 on the display unit 14. The message screen D1 includes a message that prompts the user to change the password of the printer 10 and an input field for input of a new password. The initial password is at a higher risk of being known by a third party than a password designated by the user. Therefore, if the initial password remains set for the printer 10, a third party may use the printer 10 illegitimately. In the present embodiment, the printer 10 displays the message screen D1 in the security process of FIG. 3 and thus can appropriately prompt the user to change the password. Therefore, the security of the printer 10 can be enhanced.

In S60, the CPU 32 disables the first communication port (i.e., port numbers “80” and “515”). Thus, after this, when receiving a request signal that includes the relatively low-security port number “80” (or “515”), the printer 10 does not execute a process according to the request signal (NO in S4 of FIG. 3). Thus, it is possible to prevent the printer 10 from executing a process according to an illegitimate request signal. Therefore, the security of the printer 10 can be enhanced.

In S60, the printer 10 does not disable the fourth communication port (i.e., port number “443”). With https corresponding to the port number “443”, relatively high-security communication including user authentication is executed. Therefore, even if the printer 10 executes a process according to https in response to a request signal from the attacking terminal user authentication will fail in the course of process. Thus, it is possible to prevent the printer from subsequently executing a process according to the illegitimate request signal. Since the printer 10 does not disable the fourth communication port, the legitimate user (i.e., the user of the user terminal 60) can send an https request signal to the printer 10 to cause the printer 10 to execute a desired process.

In S62, the CPU 32 stores log information in the memory 34. The log information includes the destination port number of the request signal, the IP address of the sender of the request signal, receipt date of the request signal, etc. For any request signals received after S62 as well, their log information is cumulatively stored in the memory 34. For example, if the type of the destination port of the request signal is the second communication port (i.e., the port number “25”, “445”, or “22”), the log information indicates that the request signal for the second communication port has been received. That is, this log information indicates that a request signal intended to cause the printer 10 to execute a process according to an app that is not stored in the printer 10 has been received. Therefore, an administrator of the printer 10 is able to know that suspicious communication has been executed by seeing the log information. Accordingly, the administrator can take measures to enhance the security of the printer 10 (e.g., strengthen the firewall of LAN). In a modification, the CPU 32 may store the log information in a server other than the printer 10 in S62.

In S64, the CPU 32 sends a first notification e-mail to an e-mail address stored in the memory 34 as a recipient. This e-mail address is stored in advance in the memory 34, for example, by the administrator of the printer 10. The first notification e-mail includes the destination port number of the request signal. That is, the first notification e-mail indicates that the request signal for the destination port has been received. For example, if the type of the destination port of the request signal is the second communication port (i.e., port number “25”, “445”, or “22”), the first notification e-mail indicates that the request signal for the second communication port has been received. That is, the first notification e-mail indicates that a request signal intended to cause the printer 10 to execute a process according to an app that is not stored in the printer 10 has been received. Therefore, the administrator of the printer 10 is able to know that suspicious communication has been executed by reading the first notification e-mail. Accordingly, the administrator can take measures to enhance the security of the printer 10. The first notification e-mail further includes the port number corresponding to the port disabled in S60. Thus, the administrator is able to know that the port has been disabled.

In S66, the CPU 32 starts the timer. Thus, the CPU 32 can recognize that the security process is ongoing.

The CPU 32 proceeds to S70.

In S70, the CPU 32 stores the IP address of the sender of the request signal (i.e., the IP address of the target terminal) in the blacklist 38B. This allows the printer 10 to determine YES in S6 in FIG. 3 when the printer 10 receives a request signal from the target terminal again, and thus does not execute S10 nor the subsequent steps. Therefore, it is possible to prevent the printer 10 from executing a process according to the illegitimate request signal thereafter.

(Timer Monitoring Process; FIG. 5)

Referring to FIG. 5, a timer monitoring process is described. The process of FIG. 5 is triggered by the timer being started in S66 of FIG. 4.

In S80, the CPU 32 monitors whether a measured period by the timer has reached a predetermined period (e.g., 60 minutes). If the measured period has reached the predetermined period, the CPU 32 determines YES in S80 and proceeds to S82.

In S82, the CPU 32 deletes the IP address of the sender on the blacklist 38B. This reduces the amount of data in the blacklist 38B.

In S84, the CPU 32 enables the first communication port (i.e., port numbers “80” and “515”). Thus, when receiving a request signal including the port number “80” (or “515”) again, the printer 10 can execute a process according to the request signal. This improves the convenience of the user.

In S86, the CPU 32 stops storing the log information in the memory 34. This prevents storage of an enormous number of pieces of log information in the memory 34.

In S88, the CPU 32 sends a second notification e-mail to an e-mail address stored in the memory 34 as a recipient. This e-mail address is the same as the e-mail address used in S64 of FIG. 4. The second notification e-mail includes the port number corresponding to the port enabled in S84. Thus, the administrator is able to know that the port has been enabled.

In S90, the CPU 32 resets the timer. As a result, the security process ends, and the process of FIG. 5 ends.

(Specific Case; FIGS. 6 to 8)

Next, referring to FIGS. 6 to 8, a specific case implemented by the processes of FIGS. 3 to 5 is described. In the initial state of FIG. 6, all ports of the printer 10 are enabled and the password 42 is the initial password. Further, in the memory 34, an e-mail address of the user terminal 60 is stored as an e-mail address of the administrator of the printer 10.

In T2, the user terminal 60 sends a http request signal to the printer 10. This request signal includes a destination port number “80” and the IP address “aaa” of the sender.

When receiving the http request signal from the user terminal 60 in T2 (YES in S2 of FIG. 3), the printer 10 executes a process according to the http request signal by using the app corresponding to http (YES in S4, NO in S6, NO in S10, S12).

Thereafter, the attacking terminal 70 sends a smb request signal to the printer 10 in T10. This request signal includes a destination port number “445” and the IP address “bbb” of the sender.

When receiving the smb request signal from the attacking terminal 70 in T10 (YES in S2 of FIG. 3), the printer 10 executes the security process (YES in S4, NO in S6, YES in S10, NO in S20, S30). Specifically, the printer 10 displays the message screen D1 on the display unit 14 in T12 (YES in S52 of FIG. 4, S54). In this instance, the printer 10 accepts input of a new password from the user in T14 and changes the password 42 from the initial password to the new password in T16. In addition, the printer 10 disables the first communication port (i.e., port numbers “80” and “515”) in T18 (S60). The printer 10 then stores log information L1 in the memory 34 in T20 (S62). The log information L1 includes the receipt date of the smb request signal received in T10, the destination port number “445”, and the IP address “bbb” of the sender. Further, the printer 10 sends a notification e-mail M1 to the user terminal 60 in T22 (S64).

When receiving the notification e-mail M1 from the printer 10 in T22, the user terminal displays the notification e-mail M1 in T24. The notification e-mail M1 includes a message indicating that a suspicious signal has been received for the second communication port (i.e., port number “445”) and a message indicating that the first communication port (i.e., port numbers “80” and “515”) has been disabled.

The printer 10 starts the timer in T26 (S66 in FIG. 4). Further, the printer 10 stores the IP address “bbb” of the sender of the smb request signal received in T10 (i.e., the IP address of the attacking terminal 70) in the blacklist 38B in T28 (S70). Then, in T30, the printer 10 sends a response signal to the smb request signal received in T10 to the attacking terminal 70 (S40 in FIG. 3). In the present case, the smb request signal is a so-called port scan signal, and the response signal includes information indicating that the port number “445” is enabled.

When receiving the response signal from the printer 10 in T30, the attacking terminal attempts to send request signals to the other ports. That is, the attacking terminal 70 sends an http request signal to the printer 10 in T40. This request signal includes the destination port number “80” and the IP address “bbb” of the sender.

When receiving the http request signal from the attacking terminal 70 in T40 (YES in S2 of FIG. 3), the printer 10 determines in T42 that the port corresponding to the port number “80” is disabled (see T18) (NO in S4) and does not execute a process according to the http request signal.

Further, in T50, the attacking terminal 70 sends a telnet request signal to the printer 10. This request signal includes a destination port number “23” and the IP address “bbb” of the sender.

When receiving the telnet request signal from the attacking terminal 70 in T50 (YES in S2 of FIG. 3), the printer 10 determines in T52 that the IP address “bbb” of the sender is on the blacklist 38B (see T28) (YES in S6) and does not execute a process according to the telnet request signal.

Further, the attacking terminal 70 causes another attacking terminal 72 to send an http request signal to the printer 10 in T60. This request signal includes the destination port number “80” and an IP address “ccc” of the sender.

When receiving the http request signal from the attacking terminal 72 in T60 (YES in S2 of FIG. 3), the printer 10 determines in T62 that the port corresponding to the port number “80” is disabled (see T18) (NO in S4) and does not execute a process according to the http request signal. In T70 of FIG. 7, the user terminal 60 sends a telnet request signal to the printer 10. This request signal includes the destination port number “23” and the IP address “aaa” of the sender.

When receiving the telnet request signal from the user terminal 60 in T70 (YES in S2 of FIG. 3), the printer 10 sends authentication screen data to the user terminal 60 in T72 (YES in S4, NO in S6, YES in S10, YES in S20, NO in S22, S24).

When receiving the authentication screen data from the printer 10 in T72, the user terminal 60 displays an authentication screen D2 in T74. The authentication screen D2 includes an input field for a password. The user terminal 60 accepts input of a password 43 from the user in T76 and sends the password 43 to the printer 10 in T78.

When receiving the password 43 from the user terminal 60 in T78, the printer 10 compares the password 43 with the password in the memory 34 in T80. In the present case, the password 43 has been stored in T16 of FIG. 6 and thus the two passwords match, resulting in success in user authentication (YES in S24). In this instance, the printer 10 stores the IP address “aaa” of the sender in the whitelist 38W in T82 (S26). The printer 10 then sends a success notification indicating that the user authentication succeeded to the user terminal 60 in T84.

When receiving the success notification from the printer 10 in T84, the user terminal sends a setting change request including a setting value to the printer 10 in T86.

When receiving the setting change request from the user terminal 60 in T86, the printer stores the setting value included in the setting change request in T88 (S12 in FIG. 3).

In T90 of FIG. 8, the printer 10 detects that a measured period by the timer has reached a predetermined period (YES in S80 of FIG. 5). In this instance, the printer 10 clears the blacklist 38B in T92 (S82). Accordingly, the IP address “bbb” is deleted from the blacklist 38B. The printer then enables the first communication port (i.e., port numbers “80” and “515”) in T94 (S84). Further, the printer 10 stops storing the log information in the memory 34 in T96 (S86). The printer sends a notification e-mail M2 to the user terminal 60 in T98 (S88).

When receiving the notification e-mail M2 from the printer 10 in T98, the user terminal displays the notification e-mail M2 in T100. The notification e-mail M2 includes a message indicating that the first communication port (i.e., port numbers “80” and “515”) has been enabled.

The printer 10 then resets the timer in T102 (S90).

In T110, the attacking terminal 70 sends a telnet request signal to the printer 10. This request signal includes the destination port number “23” and the IP address “bbb” of the sender.

The IP address “bbb” was deleted from the blacklist 38B in T92 (NO in S6 of FIG. 3). In this instance, the printer 10 sends authentication screen data to the attacking terminal 70 in T112 (YES in S10, YES in S20, NO in S22, S24).

The attacking terminal 70 does not send a password to the printer 10 in response to receiving the authentication screen data from the printer 10 in T112. As a result, user authentication fails (NO in S24 of FIG. 3).

In this instance, the printer 10 executes the security process (S30). T118 to T130 are the same as T18 to T30 in FIG. 6, except that the destination port number “23” is stored in log information L2 and that a notification e-mail M3 including a message indicating that a suspicious signal has been received for the port corresponding to the port number “23” is sent.

### Effects of Embodiment

The printer 10 does not store the app corresponding to the second communication port (i.e., port numbers “25”, “445”, and “22”) in the memory 34. Thus, a request signal for the second communication port may be an illegitimate request signal (e.g., port scan). When receiving a request signal for the second communication port (T10 in FIG. 6), the printer 10 executes the security process (T12, T18, T20, T22, T28). Therefore, the security of the printer 10 can be enhanced. Further, the printer 10 automatically executes the security process in response to the receipt of the request signal for the second communication port, without receiving an instruction for security enhancement (e.g., an instruction to disable the first communication port) from the user. Therefore, the convenience of the user can be improved. Further, for example, in a communication environment where a firewall is provided for the LAN (not shown) to which the printer 10 and the user terminal 60 belong, the printer 10 usually does not receive a request signal for the second communication port from the attacking terminal 70 on the Internet. That is, it can be said that the environment where the printer 10 can receive a request signal for the second communication port is a low-security communication environment. The printer 10 of the present embodiment is particularly useful in such low-security communication environments.

(Correspondence Relationships)

The printer 10 is an example of “communication device”. The http request signal of T2 and the smb request signal of T10 in FIG. 6, and the telnet request signal of T70 in FIG. 7 are examples of “first request signal”, “second request signal”, and “third request signal”, respectively.

S12 in FIGS. 3 and T4 in FIG. 6 are examples of “execute a process according to the first request signal”. S12 in FIGS. 2 and T88 in FIG. 7 are examples of “execute a process according to the third request signal”. S30 in FIG. 3 is an example of “in a case where a second request signal for the second communication port is received in a state where the second communication port is enabled, execute a security process” and “in a case where the third request signal is received and the predetermined permission condition is not satisfied in the state where the third communication port is enabled, execute the security process”. S84 in FIGS. 5 and T94 in FIG. 8 are examples of “enable the first communication port”. S26 in FIGS. 3 and T82 in FIG. 7 are examples of “store an IP address of a sender of the third request signal in the whitelist”.

### SECOND EMBODIMENT

Next, a second embodiment is described. In S60 of FIG. 4, the CPU 32 disables not only the first communication port (i.e., port numbers “80” and “515”) but also the third communication port (i.e., port numbers “20”, “21”, and “23”). As a result, while the security process is ongoing, the printer 10 does not execute processes according to request signals corresponding to ftp and telnet (NO in S4 of FIG. 3). Therefore, the security of the printer 10 can be further enhanced. In S84 of FIG. 5, the CPU 32 enables not only the first communication port but also the third communication port.

### THIRD EMBODIMENT

Next, a third embodiment is described. In S60 of FIG. 4, the CPU 32 disables not only the first communication port but also the second communication port (i.e., port number “25”, “445” or “22”). As a result, when receiving a request signal for the second communication port while the security process in ongoing, the printer 10 determines NO in S4 and thus does not execute S6 and the subsequent steps. Therefore, the processing load of the printer 10 can be reduced. In S84 of FIG. 5, the CPU 32 enables not only the first communication port but also the second communication port.

### FOURTH EMBODIMENT

Next, a fourth embodiment is described. In S24 of FIG. 3, the CPU 32 determines whether the request signal includes a command specific to the printer 10 or not, instead of executing the user authentication. This specific command means a specific command system developed by the vendor of the printer 10. A terminal from which a request signal including the specific command is sent is highly probably a legitimate terminal equipped with an application program provided by the vendor of the printer 10. Therefore, in the present embodiment, when the request signal includes the specific command, the CPU 32 determines YES in S24 (i.e., determines that the sender is a legitimate terminal). According to this configuration, the printer 10 can appropriately execute a process according to a request signal from a secure terminal as a communication counterpart, without executing user authentication.

In a modification, the printer 10 may determine NO in S24 (i.e., determine that the sender is not a legitimate terminal) if the request signal includes a command system (e.g., Unix (registered trademark) command) that is presumed to be port scan.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

While specific examples of the present invention have been described in detail above, these are merely illustrative and do not limit the scope of the claims. Various modifications and variations of the specific examples described above are included in the technology described in the claims. Modifications of the above embodiments are listed below.

(Modification 1) The printer 10 may not execute S60 of FIG. 4. Generally speaking, the security process may not include the process of disabling the first communication port.

(Modification 2) The printer 10 may not execute S84 of FIG. 5. In the present modification, “enable the first communication port” may be omitted.

(Modification 3) If the destination port is the second or third communication port (YES in S10), the printer 10 may execute the security process without executing S20 to S24. That is, the “predetermined permission condition” may be omitted.

(Modification 4) The printer 10 may disable the fourth communication port in S60 of FIG. 4. Generally speaking, the security process may include a process of disabling the fourth communication port.

(Modification 5) The printer 10 may not include the whitelist 38W. In this modification, S22 and S26 in FIG. 3 may be omitted.

(Modification 6) The printer 10 may not execute S54 in FIG. 4. Generally speaking, the security process may not include the process of displaying the message screen on the display unit. In another modification, the printer 10 may display the message screen D1 on the display unit 14 in the security process, regardless of whether the current password is the initial password.

(Modification 7) The printer 10 may not include the blacklist 38B. In this modification, S70 in FIG. 4 may be omitted.

(Modification 8) The printer 10 may not execute S62 in FIG. 4. Generally speaking, the security process may not include the process of storing the log information in the memory.

(Modification 9) The security process may not include S64 in FIG. 4. Generally speaking, the security process may not include the process of notifying the user of receipt information.

(Modification 10) In the above embodiments, the processes of FIGS. 3 to 8 are implemented by the CPU 32 of the printer 10 executing the program 36. Alternatively, any of these processes may be implemented by hardware such as a logic circuit.

The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A communication device comprising:
a memory configured to store a first application program corresponding to a first communication port and not to store a second application program corresponding to a second communication port, and
a controller,
wherein the controller is configured to:
in a case where a first request signal for the first communication port is received in a state where the first communication port is enabled, execute a process according to the first request signal by the first application program; and
in a case where a second request signal for the second communication port is received in a state where the second communication port is enabled, execute a security process related to security of the communication device.

2. The communication device according to claim 1, wherein
the security process includes a process of disabling the first communication port.

3. The communication device according to claim 2, wherein
the security process further includes a process of disabling the second communication port.

4. The communication device according to claim 2, wherein
the controller is further configured to enable the first communication port in a case where a predetermined period has elapsed after the first communication port was disabled.

5. The communication device according to claim 2, wherein
the memory is further configured to store a fourth application program corresponding to a fourth communication port,
the fourth communication port is for more secure communication compared to the first communication port, and
the security process does not include a process of disabling the fourth communication port.

6. The communication device according to claim 1, wherein
the memory is further configured to store a third application program corresponding to a third communication port,
the controller is further configured to:
in a case where a third request signal for the third communication port is received and a predetermined permission condition is satisfied in a state where the third communication port is enabled, execute a process according to the third request signal by the third application program; and
in a case where the third request signal is received and the predetermined permission condition is not satisfied in the state where the third communication port is enabled, execute the security process.

7. The communication device according to claim 6, wherein
the security process includes a process of disabling the first communication port.

8. The communication device according to claim 7, wherein
the security process further includes a process of disabling the third communication port.

9. The communication device according to claim 7, wherein
the memory is further configured to store a fourth application program corresponding to a fourth communication port,
the fourth communication port is for more secure communication compared to the first communication port, and
the security process does not include a process of disabling the fourth communication port.

10. The communication device according to claim 6, wherein
the communication device further comprises a whitelist, and
in a case where an IP address of a sender of the third request signal is on the whitelist, the predetermined permission condition is satisfied.

11. The communication device according to claim 6, wherein
in a case where user authentication for a sender of the third request signal succeeds, the predetermined permission condition is satisfied.

12. The communication device according to claim 11, wherein
the communication device further comprises a whitelist, and
the controller is further configured to, in a case where the third request signal satisfies the predetermined permission condition, store an IP address of a sender of the third request signal in the whitelist.

13. The communication device according to claim 6, wherein
in a case where the third request signal includes a command specific to the communication device, the predetermined permission condition is satisfied.

14. The communication device according to claim 13, wherein
the communication device further comprises a whitelist, and
the controller is further configured to, in a case where the third request signal satisfies the predetermined permission condition, store an IP address of a sender of the third request signal in the whitelist.

15. The communication device according to claim 1, wherein
the communication device further comprises a display unit, and
the security process includes a process of displaying a message screen on the display unit in a case where a current password of the communication device is an initial password, the message screen including a message that prompts a user to change a password of the communication device.

16. The communication device according to claim 1, wherein
the communication device further comprises a blacklist, and
the security process includes a process of storing an IP address of a sender of the second request signal in the blacklist.

17. The communication device according to claim 1, wherein
the security process includes a process of storing log information in the memory, the log information indicating that the second request signal for the second communication port has been received.

18. The communication device according to claim 1, wherein
the security process includes a process of notifying a user of receipt information indicating that the second request signal for the second communication port has been received.

19. A non-transitory computer-readable recording medium storing computer-readable instructions for a communication device, wherein
the communication device comprises a memory configured to store a first application program corresponding to a first communication port and not to store a second application program corresponding to a second communication port,
the computer-readable instructions, when executed by a processor of the communication device, cause the communication device to:
in a case where a first request signal for the first communication port is received in a state where the first communication port is enabled, execute a process according to the first request signal by the first application program; and
in a case where a second request signal for the second communication port is received in a state where the second communication port is enabled, execute a security process related to security of the communication device.
